(19) United States
(12) Patent Application Publication
(10) Pub. No.: US 2018/0044193 A1
(43) Pub. Date: Feb. 15, 2018

(54) Process to Recycle and Reuse Trona and Coal Combustion Byproducts in a Coal-Fired Power Plant

(71) Applicant: Robert L. Smith, Murphy, NC (US)

(72) Inventor: Robert L. Smith, Murphy, NC (US)

(73) Assignee: Ash Recovery Systems, Inc., Jefferson, GA (US)

(21) Appl. No.: 15/231,860

(22) Filed: Aug. 9, 2016

(51) Int. Cl. C01D 7/16; B03B 1/04; B01J 20/34; C01D 7/26; C09K 3/18; B01J 20/04; B03D 1/02; C01D 7/28

(52) U.S. Cl. CPC C01D 7/16; B03D 1/02; B03B 1/04; C01D 7/28; C01D 7/26; C09K 3/18; B01J 20/043; B01J 20/3433; B01J 20/3475

(57) ABSTRACT

A process is developed wherein sodium carbonate is reclaimed from Trona-treated fly ash waste stream, and the fly ash rendered suitable for use as a Pozzolan. The process is a closed system wherein all separated aspects of the waste stream are reused by the generating power plant or offered as a commercial product.

### CROSS REFERENCE TO RELATED APPLICATIONS

This application claims the benefit of U.S. Provisional Application No. 62/216,856, 10 Sep., 2015

### CITED AS PRIOR ART

Fly ash beneficiation process, U.S. Pat. No. 4,121,945 A, Apr. 16, 1978, Vernon J. Hurst & Robert W Styron (Inventors)

Method of removing carbon from fly ash, U.S. Pat. No. 6,068,131 A, Jul. 13, 1999, Robert W. Styron & Jiann-Yang Hwang (Inventors)

### BACKGROUND OF THE INVENTION

Coal fly ash is produced by the combustion of pulverized coal at high boiler temperatures in modern electric power generating plants. Coal combusted in these facilities produces a combustion residual (ash) that is normally formed as both: coarse aggregate ‘bottom ash’ captured and removed from the bottom of the units; and fine particulate ‘fly ash’ removed from the flue gas stream via electrostatic precipitation or bag houses. The fly ash is fused into particles partially consisting of glass beads and spheroids. Most fly ash has the particle size consistency to pass through a #200-sized US mesh, with much minus #325-mesh in size. The very fine glassy fly ash particles are termed “pozzolanic” because of their ability to react with lime in the presence of water to form cementitious materials.

Pozzolanic fly ash is used extensively in the concrete industry. Fly ash replaces a portion of the Portland cement requirement producing a more economical product and benefiting the concrete with enhanced characteristics. During the hydration of the Portland cement, lime is produced. The lime contributes nothing to the hardened strength of the concrete, but creates durability problems. The pozzolanic coal fly ash reacts with this ‘free lime’, the cement hydration byproduct, to produce additional cementitious material and improve durability of the concrete. A guide for the use of fly ash in concrete is provided by the American Concrete Institute in ACI 226. Specifications and testing procedures for fly ash for use in concrete are provided in ASTM C618 and ASTM C311.

The power plant combustion of coal results in the formation of sulfur oxide gases from the small amount of sulfur in the coal. Most of this sulfur is in the form of sulfur dioxide (SO₂), but a small percentage is present as sulfur trioxide (SO₃). Formation of sulfur trioxide, or its hydrated form, sulfuric acid, is a constant problem for the generator and constitutes an environmental hazard. The generator through modified operations and maintenance and the introduction of flue gas sorbents seeks to mitigate the problems. The injection of sorbents, such as Trona, is very effective in mitigating the formation of sulfur trioxide.

Trona (Na₂CO₃.NaHCO₃.2H₂O), Sodium Sesquicarbonate, is a naturally occurring mineral mined near Green River, Wyo. When injected into the combustor flue gas stream to remove sulfur trioxide, the Trona is calcined in the hot flue gases (>275° F.) to form porous sodium carbonate (Na₂CO₃), which hastens the reaction with sulfur trioxide. Unfortunately, the reaction products end up attached to the surface of the fly ash particles as sodium sulfate (Na₂SO₄) or sodium sulfite (Na₂SO₃). Thus contaminated, if the fly ash is used in concrete, problems occur such as early stiffening of the hydrating mix, low strength gain and alkali-aggregate expansion.

This process reclaims sodium carbonate from the fly ash, renders the ash and sodium carbonate for beneficial reuse, and sequentially generates other commercial products from the power plant waste stream. Once the ash is in a slurry condition, normally but not restricted to water amounts greater than 30% by weight of dry ash, all process steps are possible and can be initiated when deemed economically and operationally viable by entities controlling the ash.

### SUMMARY OF THE INVENTION

The quest for a cleaner environment often can create other problems. Such is the case for coal-fired power plants which have installed selective catalytic reduction (SCR) systems which have conversely increased the emissions of SO₃. The most common method to remove this SO₃ from the waste gas stream is to inject a sorbent into the flue gas to react with the SO₃ and form a solid compound which can be removed downstream in the particle collection system. Trona, a sodium bicarbonate compound, is one popular sorbent of choice. However, the use of Trona has caused disposal and beneficial use problems for the coal ash and elevated levels of hazardous constituents in the ash such as arsenic, selenium and mercury. This patent provides a method to recycle Trona, produce marketable coal combustion byproducts, and lower levels of the hazardous elements in the aqueous discharge.

The ultimate goal of this patent is to recycle and/or reuse all the fly ash combustion products. The process is outlined in the flow diagram.

### Process Flow to Recycle Trona and Render Fly Ash Useable

1. Fly Ash Laden with sulfur contaminants—Fed from Storage Silo or Storage Area (Either Dry or Water Conditioned) to Treatment Facility
   Fly Ash+Water to Slurry

Fly Ash Slurry Introduced into Agitation Tank with Cenospheres Removal System
2. Cenospheres collected as Fly Ash transferred to Wet Magnetic Separator and Froth Flotation Tank

Cenospheres go to Drier and to Storage Silo

Removed Moisture to Common Water Condenser for Return to Slurry Make-Up Water
3. Fly Ash passes through Wet Magnetic Separator which removes all magnetics and dumps slurry into Froth Flotation Tank. Fly ash treated in Froth Flotation fashion with introduction of particle conditioner and flotation reagent and infused with air.
   Resulting Carbon and Iron laden fractions processed through Driers
   Dried materials go to Silo Storages

Removed Moistures to Common Water Condenser for Return to Slurry Make-Up Water
4. Fly Ash dewatered
   Fly Ash to Drier (mill system if necessary) and to Storage Silo

Removed Moisture to Common Water Condenser for Return to Slurry Make-Up Water
5. All Process Waste Water collected in Settling Tank/Basin
   Process Water treated with Calcium Chloride precipitating Calcium Carbonate, Calcium
   Sulfite and Calcium Sulfate and resulting in Sodium Chloride Brine

Precipitates Removed to Temporary Storage and Future Use or Sale.
6. Brine Concentrate treated with Solvay Process resulting in reclaimed Sodium Carbonate
   Sodium Carbonate is dewatered
   Sodium Carbonate to Drier and to Storage Silo

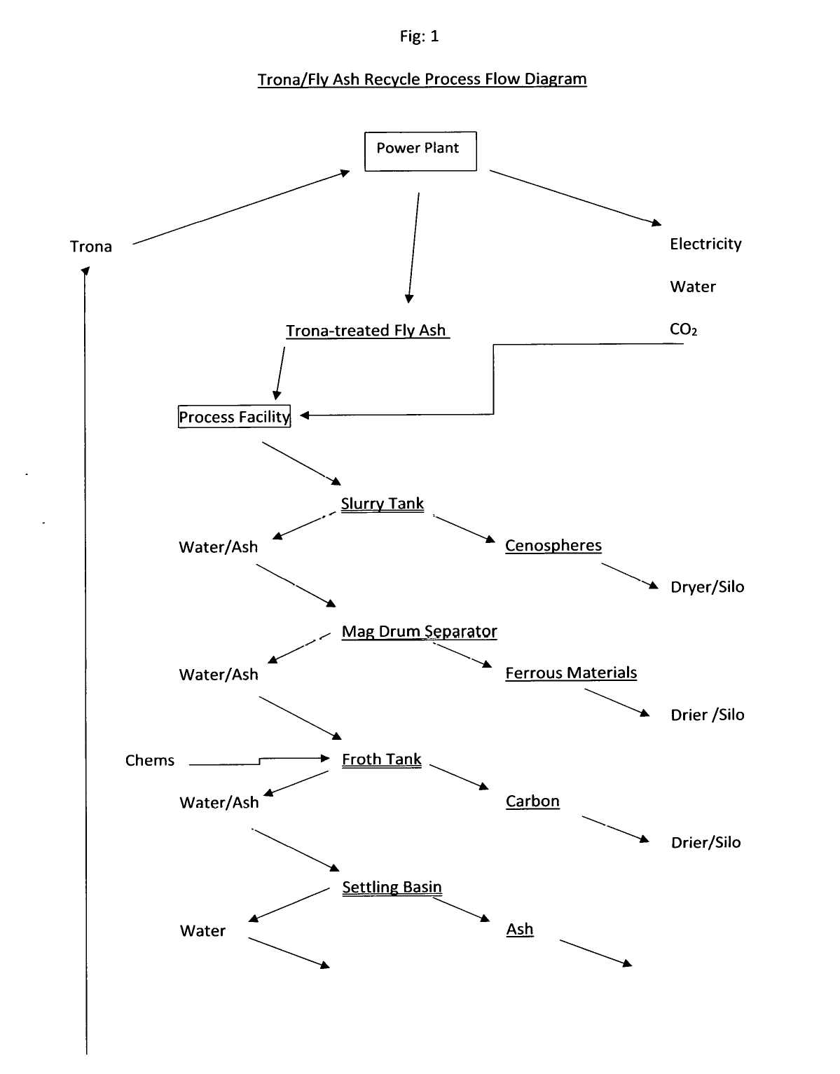

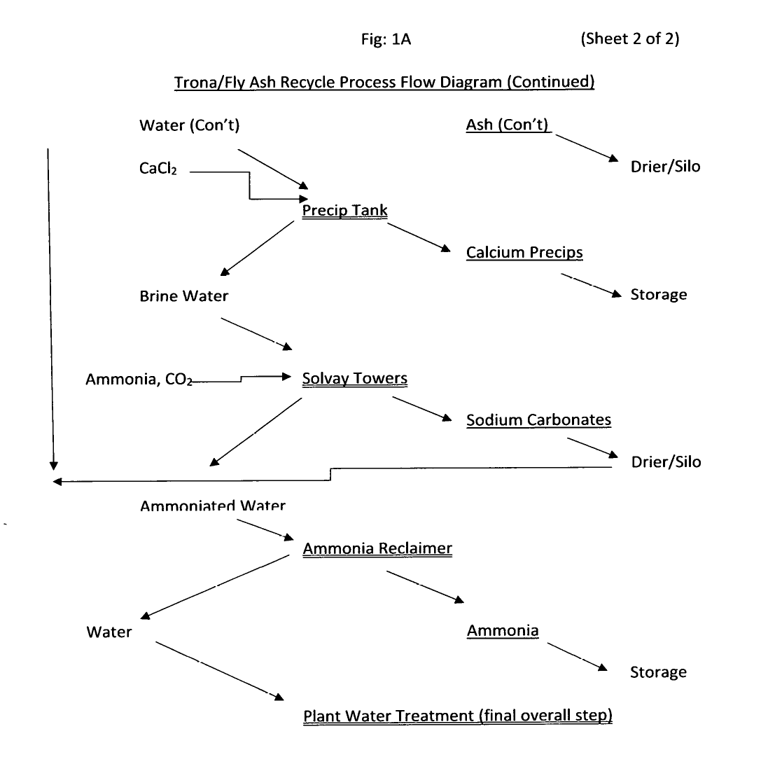

Removed Moisture to Water Condenser. Waste Water to Ammonia Extraction System and all Collected Waters to Final Water Treatment
Reference Trona/Fly Ash Recycle Process Flow Diagram, FIGS. 1 & 1A

The fly ash with the Trona residue, typically sodium carbonate, sodium sulfite and sodium sulfate, is washed to remove these soluble salts. In the washing process floaters called Cenospheres rise to the water surface and can be removed, mechanically or pneumatically, dried, and stored for future sale. A method for removal could be accomplished via vacuum skimming prior to transferring the slurry through a magnetic drum separator. In the magnetic separator, principally iron-laden particles are removed from the slurry. This material is dried and sent to silo storage. Further, and directly from the drum separator discharge and prior to the froth flotation tank, the slurry is treated with a ‘particle conditioner’ which renders ash particles hydrophobic. Once the slurry enters the froth flotation tank a ‘flotation reagent’ is added and the ash slurry is infused with air bubbles. Carbon laden particles attach to the rising air bubbles creating a froth on the surface of the water, which is then removed and the remaining slurry transferred to a settling tank/basin. The carbon-laden ash is dried and sent to silo storage. Beneficiated ash is settled and the water decanted from the tank/basin. The ash is then collected, dried and sent to silo storage for distribution. The viability of the different steps in the process is determined by the recoverable percentages of each resulting product. Variations in ashes inherent in power generation would place expectations in recoverable product at: 0-5% for Cenospheres, 1-10% for magnetics and 1-20% for carbon, by weight of dry ash treated, but exceptions are probable. The recovered ash, after drying, may need comminution to increase reactivity; a process step easily added between drier and ash storage silo.

Up to this point in the process, efforts have been concentrated on removal of physical aspects of the slurry. The liquid phase from the washing operation contains the soluble salts sodium carbonate, sodium sulfate and sodium sulfite. To this brine is added calcium chloride (CaCl₂). Calcium carbonate (CaCO₃), calcium sulfate (CaSO₄) and calcium sulfite (CaSO₃) precipitate and are captured and removed from the water body. This material may be mixed while still water-saturated with fly ash and lime to produce stabilized road base material or pond liner material. During the precipitation phase, reducing or oxidizing agents may be added to aid removal of hazardous elements such as arsenic and selenium. These elements are carried away with the precipitate and encapsulated in the final material/product matrix.

After removal of the precipitants the remaining liquid contains sodium chloride (NaCl). The sodium chloride brine is the main raw ingredient for the Solvay process which produces sodium bicarbonate or sodium carbonate. In this process ammonia bubbles up through the salt brine and is absorbed by it. The ammoniated brine is then treated by bubbling carbon dioxide (CO₂) through it, precipitating sodium carbonate. The ammonia catalyst can be reclaimed from the water after sodium carbonate is collected and returned to the process. The sodium carbonate is dried and returned to the flu gas injection system or retained for commercial sale.

The entire process is cyclic in nature. The power producer uses Trona. It provides fly ash, power and water. It receives in return, five commercial products, recycled ammonia, sodium carbonate as Trona replacement, treated make-up water, and greatly reduced disposal costs.

All process water captured and reclaimed from product production is treated and returned to the plant. Some of the final captured water may be distributed as ice control brine, or further processed to remove the calcium chloride.

Though this process is designed for integration into the ash management systems of the generating power plant, it is also recognized as an independent process operation that could be utilized separate from the ash generation facility and by others seeking the beneficiation of coal combustion materials which are in their control and/or ownership.

### DETAILED DESCRIPTION OF THE INVENTION

The Trona treated ash is mixed with water to a 10:1, water to solids ratio. After mixing, the solids are settled and the supernatant water is decanted. The solids are then dried. After drying the ash in examples #1 and #3 are ground in a ball mill. In example #2, the magnetic portion of the ash is removed, then the ash is ground through a ball mill.

Example #1 is a fly ash resulting from a very heavy Trona dosage as indicated by the large percentage of sodium in the ash. After washing, the amount of sodium oxide in the ash was reduced from 24.17% to 3.71% and the sulfur trioxide was lower from 6.55% to 1.05%. The strength activity index (SAI) is a procedure in ASTM C311 whereby the unconfined compressive of a mortar mix of sand, cement, fly ash and water is compared to that of a mortar mix without the fly ash. In example #1, the SAI of the unwashed ash was very low and the mortar mix exhibited early stiffening, that is it ‘set up’ very fast. Ball milling the unwashed ash exacerbated the fast setting times and low strength. After removing most of the Trona residue from the ash but before ball milling, the SAI did not improve much. This ash also had a good amount of carbon, which along with the increased amount of >#325-mesh sized particles lead to a high-water requirement and low strength. This sample is a good candidate for carbon removal by froth flotation, but the procedure was not performed on this sample. After ball milling, this sample produced excellent results.

Example #2 is a fly ash resulting from a low Trona dosage and with a high iron content as indicated by the low percentage of sodium and high percentage of iron in the ash. After washing, the amount of sodium oxide in the ash was reduced from 2.1% to 0.5% and the sulfur trioxide was lowered from 2.45% to 0.39%. In Example #2, the SAI of the unwashed ash was low. Ball milling the unwashed ash greatly increased the SAL After removing most of the Trona residue from the ash, the SAI was slightly better. The magnetic fraction of this sample was removed. The iron oxide content of the ash was reduced from 24.55% to 10.91%. The pozzolanic nature of coal fly ash has been attributed to the amorphous silica and alumina in the ash. Therefore, removal of the iron-rich magnetic fraction in effect increases the amount of pozzolanic silica and alumina and increases its reactivity. There is some increase in the SAI on the nonmagnetic fraction compared to the raw sample, especially after ball milling, when this sample produced excellent results. The wash water contained 0.121 mg/L of arsenic and 0.661 mg/L of selenium. After precipitating the sulfite ions with calcium chloride, the water contained 0.083 mg/L of arsenic and 0.295 mg/L of selenium.

Example #3 is a fly ash resulting from a low Trona dosage and with a medium iron content as indicated by the low percentage of sodium and medium percentage of iron in the ash. After washing, the amount of sodium oxide in the ash was reduced from 3.62% to 1.13% and the sulfur trioxide was lowered from 3.75% to 0.92%. In Example #3, the SAI of the unwashed ash was low. The unwashed ash was not ball milled. After removing most of the Trona residue from the ash, the SAI was considerably better. Ball milling this sample produced excellent results.

### Example #1: High Trona-Treated Fly Ash (Lab #19614)

Chemical Analysis, Weight %, Ignited Basis

| | 19614 | 19614ww |
|---|---|---|
| SiO₂ | 39.94 | 55.66 |
| Al₂O₃ | 19.63 | 27.41 |
| Fe₂O₃ | 03.69 | 05.27 |
| Sum SAF | 63.26 | 88.34 |
| CaO | 00.94 | 01.36 |
| MgO | 00.85 | 01.16 |
| Na₂O | 24.17 | 03.71 |
| K₂O | 01.97 | 02.48 |
| SO₃ | 06.55 | 01.05 |
| Moisture | 00.68 | 00.37 |
| Loss On Ignition | 16.56 | 11.31 |

Physical Analysis:

| | Amt. Ret. | Blaine | | SAI (% Control) | | | |
|---|---|---|---|---|---|---|---|
| | #325 Sieve | cm2/g | Density | 3 | 7 | 28 | WR |
| 19614* | 24.6 | 3,585 | 2.29 | 41 | 43 | 46 | 107 |
| 19614bm* | 01.2 | 9,630 | 2.48 | 29 | 36 | 34 | 91 |
| 19614ww | 41.5 | 3,315 | 2.18 | 47 | 53 | 53 | 110 |
| 19614wwbm | 00.1 | 10,960 | 2.57 | 101 | 97 | 96 | 95 |

ww—water washed
bm—ball milled
SAI—Strength Activity Index
WR—water requirement
*Exhibited early stiffening

### Example #2: Low Trona, High Iron Fly Ash (Lab #19604)

Chemical Analysis, Weight %, Ignited Basis

| | 19604 | 19604ww | 19604m | 19604mm |
|---|---|---|---|---|
| SiO₂ | 41.51 | 42.93 | 21.57 | 52.85 |
| Al₂O | 21.09 | 21.87 | 10.94 | 25.27 |
| Fe₂O₃ | 24.55 | 26.21 | 62.64 | 10.91 |
| Sum SAF | 87.16 | 91.01 | 95.15 | 89.03 |
| CaO | 04.05 | 03.79 | 02.20 | 04.61 |
| MgO | 01.03 | 01.03 | 00.57 | 01.25 |
| Na₂O | 02.13 | 00.58 | 00.20 | 00.69 |
| K₂O | 01.60 | 01.64 | 00.61 | 02.06 |
| SO₃ | 02.45 | 00.39 | 00.10 | 00.32 |
| Moisture | 00.30 | 00.11 | 00.08 | 00.17 |
| Loss On Ignition | 01.74 | 01.79 | −0.07 | 02.57 |

Physical Analysis:

| | Amt. Ret. | Blaine | | SAI (% Control) | | | |
|---|---|---|---|---|---|---|---|
| | #325 Sieve | cm2/g | Density | 3 | 7 | 28 | WR |
| 19604 | 24.1 | 2,055 | 2.65 | 78 | 80 | 80 | 98 |
| 19604bm | 00.3 | 3,840 | 2.86 | 91 | 86 | 90 | 94 |
| 19604ww | 25.6 | 1,880 | 2.67 | 79 | 77 | 86 | 98 |
| 19604wwbm | 00.1 | 4,930 | 2.89 | 78 | 82 | 90 | 95 |
| 19604nm | 22.9 | 2,150 | 2.41 | 84 | 83 | 86 | 97 |
| 19604nmbm | 00.0 | 5,005 | 2.63 | 91 | 95 | 101 | 95 |
| 19604m | 44.1 | — | 3.60 | — | — | — | — |

ww—water washed
m—magnetic
nm—nonmagnetic
bm—ball milled
SAI—Strength Activity Index
WR—water requirement

### Example #3: Low Trona Fly Ash (Lab #20164)

Chemical Analysis, Weight %, Ignited Basis

| | 20164 | 20164ww |
|---|---|---|
| SiO₂ | 48.08 | 50.52 |
| Al₂O₃ | 19.20 | 20.26 |
| Fe₂O₃ | 14.82 | 16.08 |
| Sum SAF | 82.10 | 86.86 |
| CaO | 05.61 | 05.95 |
| MgO | 01.17 | 01.27 |
| Na₂O | 03.62 | 01.13 |
| K₂O | 02.22 | 02.29 |
| SO₃ | 03.75 | 00.92 |
| Moisture | 00.33 | 00.13 |
| Loss On Ignition | 03.88 | 04.32 |

Physical Analysis:

| | Amt. Ret. | Blaine | | SAI (% Control) | | | |
|---|---|---|---|---|---|---|---|
| | #325 Sieve | cm2/g | Density | 3 | 7 | 28 | WR |
| 20164 | 12.8 | 4,340 | 2.49 | — | 71 | 72 | 98 |
| 20164ww | 13.4 | 4,365 | 2.46 | 80 | 84 | 84 | 97 |
| 20164wwjm | 00.1 | 6,985 | 2.66 | 94 | 97 | 102 | 95 |

ww—water washed
jm—jar milled
SAI—Strength Activity Index
WR—water requirement

1. A process whereby Trona-treated fly ash is beneficiated by water washing
1.a) results in the removal of Cenospheres by flotation separation
1.b) results in the removal of iron-laden particles by wet magnetic separation
1.c) results in the removal of carbon-laden particles by froth flotation

2. A process whereby Trona-treated fly ash is beneficiated by the removal of sodium contaminants
2.a) results in the removal of arsenic and selenium by use of reducing or oxidizing agents
2.b) results in the precipitation of sulfates and sulfites by addition of calcium chloride
2.c) salt brine after precipitation is useable as ice control media

3. A process whereby Trona, represented as sodium carbonates, is reclaimed from Trona-treated fly ash
3.a) results in capture of sodium carbonate through Solvay process.
